(19) United States
(12) Patent Application Publication
(10) Pub. No.: US 2018/0272478 A1
(43) Pub. Date: Sep. 27, 2018

(54) METHOD AND DEVICE FOR JOINING MEMBERS

(71) Applicant: Kabushiki Kaisha Kobe Seiko Sho (Kobe Steel, Ltd.), Hyogo (JP)

(72) Inventors: Yasuhiro MAEDA, Kobe-shi, Hyogo (JP); Jiro IWAYA, Nagoya-shi, Aichi (JP); Toru HASHIMURA, Kobe-shi, Hyogo (JP); Junya NAITOU, Kobe-shi, Hyogo (JP); Hideto KATSUMA, Kobe-shi, Hyogo (JP)

(73) Assignee: Kabushiki Kaisha Kobe Seiko Sho (Kobe Steel, Ltd.), Hyogo (JP)

(21) Appl. No.: 15/763,418

(22) PCT Filed: Aug. 22, 2016
(86) PCT No.: PCT/JP2016/074347

§ 371 Date: Mar. 26, 2018

(30) Foreign Application Priority Data
Sep. 28, 2015 (JP) 2015-190159

(51) Int. Cl. B23P 11/00; B21D 39/06; B21D 37/08

(52) U.S. Cl. CPC B23P 11/005; B21D 37/08; B21D 39/06

(57) ABSTRACT

A method for joining members of the present invention is as follows: a second member is inserted through a hole part of a first member; a guide shaft is inserted through a through hole of rubber; the rubber with the guide shaft inserted is inserted into the second member; and a drive mechanism relatively moves pushers and toward each other to compress the rubber in the extending direction of the guide shaft so that the rubber is expanded outward from inside to expand and deform at least a portion of the second member inserted into the hole part, thereby joining the second member to the first member.

### TECHNICAL FIELD

The present invention relates to a method and a device for joining members.

### BACKGROUND ART

To reduce weight of automobiles and improve safety thereof, thin steel plates called high tension steels with high strength have been used. While these high tension steels are effective for weight reduction and safety improvement, they are still heavy compared with low specific gravity materials such as aluminum. In addition, high tension steels have problems such as deterioration of formability, increase of forming load, deterioration of dimensional accuracy, and the like, due to their high strength. To solve these problems, multiple-material approach, in which an extrusion, a casting, and a press-formed part, using aluminum with specific gravity less than that of a steel sheet, are used together with a steel component, has been carried out in recent years.

In the multiple-material approach joining of a steel component and an aluminum component involves problems. A brittle intermetallic compound (IMC) is generated in an interface between a steel plate and an aluminum plate in a welding technique typified by spot welding, so that joining techniques such as electromagnetic forming bonding, screw fastening typified by fastening with a bolt and a nut, friction stir welding (FSW), a riveting, a self-piercing riveting (SPR), mechanical clinching, adhesion, and the like are practically used.

In press-fitting by electromagnetic forming, a solenoid forming coil is inserted into a pipe-like part fitted to a mating part, and an induced current is induced in the pipe-like part being a conductor by a magnetic field changed by applying an impulse current to the solenoid forming coil. An electromagnetic force is generated between a magnetic field generated by a primary current of the solenoid forming coil and the induced current flowing in an opposite direction in a circumferential direction of the pipe-like part. At this time, the pipe-like part receives a radially outward force, and the pipe-like part is deformed and expanded so as to be joined to the mating part by press-fitting. This joining method is suitable for copper and aluminum having good electric conductivity, and is also practically used in joining of automobile parts in some cases.

Patent Document 1 discloses a technique of press-fitting joining by electromagnetic forming for multiple-material approach. Specifically, a bumper reinforcement made of a shaped metal and having a hollow cross section is deformed and expanded by electromagnetic forming, and the bumper reinforcement is fitted and joined to a hole provided in a bumper stay made of an aluminum alloy.

### PRIOR ART DOCUMENT

### Patent Document

Patent Document 1: JP 2007-284039 A

### SUMMARY OF THE INVENTION

### Problems to be Solved by the Invention

As in Patent Document 1, electromagnetic forming is suitable for joining a hollow part made of copper or aluminum having good electrical conductivity to a mating part by press-fitting, and a circular shape is preferable due to its joining mechanism.

Unfortunately, joining by electromagnetic forming requires use of a solenoid coil smaller than an inner diameter of an aluminum part (aluminum pipe). Reducing a diameter of a coil when a small diameter part is joined has problems of difficulty in manufacturing of the coil, and performance and durability thereof. Particularly, regarding the difficulty in manufacturing, it is difficult to form a conductor into a coil shape, so that restrictions on a material and a cross-sectional shape of the conductor are strict. When the conductor is formed into a coil shape, a cross section of the conductor is deformed. In addition, additional capital investment for high voltage capacitors with large capacity or the like, is required. Further, the joining by electromagnetic forming cannot be applied to an aluminum part provided with a rectangular cross section, a hole, or a slit.

Even in press-fitting joining other than electromagnetic forming, members may be limited in shape. For example, elongated members cannot be disposed in a joining device such as a press machine, and thus cannot be joined by press-fitting.

It is an object of the present invention to provide a method for joining members, capable of joining two members, particularly elongated members, at low cost without being limited in shape and material of the members while reducing a load on each member and increasing joining strength.

### Means for Solving the Problems

A first aspect of the present invention provides a method for joining members including: providing a first member formed with a hole part, a hollow second member, an elastic body having a through hole, a pair of pushers that are disposed on both sides of the elastic body and that support a guide shaft extending in a horizontal direction and are movable in the guide shaft extending direction, and a drive mechanism for relatively moving the pair of pushers toward each other in the guide shaft extending direction; inserting the second member into the hole part of the first member; inserting the guide shaft into the through hole of the elastic body; inserting the elastic body, through which the guide shaft passes, into the second member; and relatively moving the pair of pushers toward each other by the drive mechanism to compress the elastic body in the guide shaft extending direction to expand the elastic body outwardly, thereby expanding and deforming at least a portion of the second member inserted into the hole part to join the second member to the first member by press-fitting.

According to this method, the elastic body is expanded radially outward to uniformly expand and deform the second member, so that local deformation can be prevented and a load on each member can be reduced. This is because the second member can be uniformly deformed by using properties of the elastic body that uniformly expands outward from radially inside after compressed in a guide shaft direction. This enables fitting accuracy to be improved to increase joining strength. In addition, this method is also simpler than electromagnetic forming and other processing methods. Electromagnetic forming is usable only for conductive materials, and is limited in cross-sectional shape and dimension of a conductor depending on a coil to be used. In contrast, this method has no limitations with respect to_cross-sectional shape or size of the members, regardless of their materials. In addition, there is no need for electrical equipment requiring a capacitor with large capacity, and it is possible to join two members at low cost. In particular, the elastic member is laterally supported by the guide shaft, and the second member is joined by press-fitting by moving the pusher in a horizontal direction (the guide shaft extending direction) to compress the elastic member, so that the second member can be disposed laterally. Thus, even an elongated second member can be joined by press-fitting. Here, the horizontal direction in which the guide shaft extends includes an inclined direction in addition to a strict horizontal direction.

It is preferable that the drive mechanism includes a cam mechanism for converting a force applied in a direction different from the guide shaft extending direction to a force in the guide shaft extending direction, and that the elastic body is compressed by the force of which the direction has been converted by the cam mechanism.

The cam mechanism enables the second member to be disposed in the horizontal direction with equipment for applying a compressive force in a normal vertical direction, so that the second member can be joined by press-fitting without being limited in shape. In particular, when the second member is long, ordinary equipment for applying a compressive force cannot join the second member by press-fitting due to limitation on dimension, however, the present structure enables the second member to be joined by press-fitting even when the second member is long.

It is preferable that the drive mechanism includes an urging portion that urges one of the pushers outwardly in the guide shaft extending direction, and that after the elastic body is compressed in the guide shaft extending direction, the one of the pushers is returned by the urging portion.

The pusher is automatically returned to its original position by the urging portion, so that there is no need to manually return the pusher to the original position, thereby workability can be improved.

It is preferable that one of the pair of pushers is fixed.

When one of the pushers is fixed, the driving mechanism needs to be provided only for the pusher on one side, and thus structure of the drive mechanism can be simplified. In addition, movement of the first member and the second member can be limited so that workability can be improved.

It is preferable that there is further provided a guide shaft moving mechanism for moving the guide shaft in the horizontal direction is further prepared, and that the elastic body, through which the guide shaft passes, is inserted into the second member by the guide shaft moving mechanism.

Since the guide shaft moving mechanism moves the guide shaft in the horizontal direction, the guide shaft and the elastic body can be reliably inserted into the second member.

A second aspect of the present invention provides a device for joining members to join a first member formed with a hole part and a hollow second member by press-fitting using an elastic body having a through hole comprising: a pair of pushers which support a guide shaft extending in a horizontal direction, the pair of pushers being disposed on both sides of the elastic body and being movable in the guide shaft extending direction; and a drive mechanism for relatively moving the pair of pushers toward each other in the guide shaft extending direction, wherein the pushers are driven by the drive mechanism, with the second member being inserted through the hole part of the first member to penetrate the first member, with the guide shaft being inserted through the through hole of the elastic body, and with the elastic body through which the guide shaft is inserted being inserted in the second member, such that the elastic body is compressed in the guide shaft extending direction and expanded outwardly, so as to expand and deform at least a portion of the second member inserted into the hole part to join the second member to the first member by press-fitting.

### Effect of the Invention

According to the present invention, the elastic body is expanded outward from inside to uniformly expand and deform the second member, so that local deformation can be prevented and a load on each member can be reduced. This enables fitting accuracy to be improved to increase joining strength. In addition, this method is simpler than electromagnetic forming and other processing methods, so that two members can be joined to each other at low coat without being limited in shape and material. In particular, the second member can be disposed laterally, so that even an elongated member can be joined.

### BRIEF DESCRIPTION OF DRAWINGS

FIG. 1A is a partial cross-sectional view before joining by press-fitting according to a first embodiment of the present invention;

FIG. 1B is a partial cross-sectional view after joining by press-fitting according to a first embodiment of the present invention;

FIG. 2A is a partial cross-sectional view before joining by press-fitting of a type in which a guide shaft rotates;

FIG. 2B is a partial cross-sectional view before joining by press-fitting of a type in which the guide shaft rotates;

FIG. 3A is a partial cross-sectional view before joining by press-fitting of an another type in which the guide shaft rotates;

FIG. 3B is a partial cross-sectional view after joining by press-fitting of an another type in which the guide shaft rotates;

FIG. 4 is a cross-sectional view showing a second member having a partition wall and a rubber inserted in the second member;

FIG. 5A is a partial cross-sectional view before joining by press-fitting in which a plurality of guide shafts are inserted into the second member having the partition wall;

FIG. 5B is a partial cross-sectional view after joining by press-fitting in which a plurality of guide shafts are inserted into the second member having the partition wall;

FIG. 6A is a perspective view in the case where the shape of the hole of the first member and the cross-sectional shape of the second member are similar;

FIG. 6B is a perspective view in the case where the shape of the hole of the first member and the cross-sectional shape of the second member are non-similar;

FIG. 7A is a perspective view before joining by press-fitting in which the first member has a hat shape;

FIG. 7B is a perspective view after joining by press-fitting in which the first member has a hat shape;

FIG. 8A is a partial cross-sectional view before joining by press-fitting in which the first member is burred;

FIG. 8B is a partial cross-sectional view after joining by press-fitting in which the first member is burred;

FIG. 9A is a view before joining by press-fitting in the case where an outer frame metal mold is disposed around the second member;

FIG. 9B is a view after joining by press-fitting in the case where an outer frame metal mold is disposed around the second member;

FIG. 10A is a partial cross-sectional view before joining by press-fitting in which the rubber in the joint portion between the first member and the second member is separated;

FIG. 10B is a partial cross-sectional view after joining by press-fitting in which the rubber in the joint portion between the first member and the second member is separated;

FIG. 11A is a partial cross-sectional view showing the first step of joining by press-fitting according to a second embodiment of the present invention;

FIG. 11B is a partial cross-sectional view showing the second step of joining by press-fitting according to a second embodiment of the present invention;

FIG. 11C is a partial cross-sectional view showing the third step of joining by press-fitting according to a second embodiment of the present invention;

FIG. 11D is a partial cross-sectional view showing the forth step of joining by press-fitting according to a second embodiment of the present invention;

FIG. 11E is a partial cross-sectional view showing the fifth step of joining by press-fitting according to a second embodiment of the present invention;

FIG. 12A is a partial cross-sectional view before joining by press-fitting according to a third embodiment of the present invention; and

FIG. 12B is a partial cross-sectional view after joining by press-fitting according to a third embodiment of the present invention.

### MODE FOR CARRYING OUT THE INVENTION

Embodiments of the present invention will be described below with reference to the accompanying drawings. In each of the embodiments described below, a first member 10 and a second member 20 are not particularly limited in material, so that the present invention can be applied to any material.

### First Embodiment

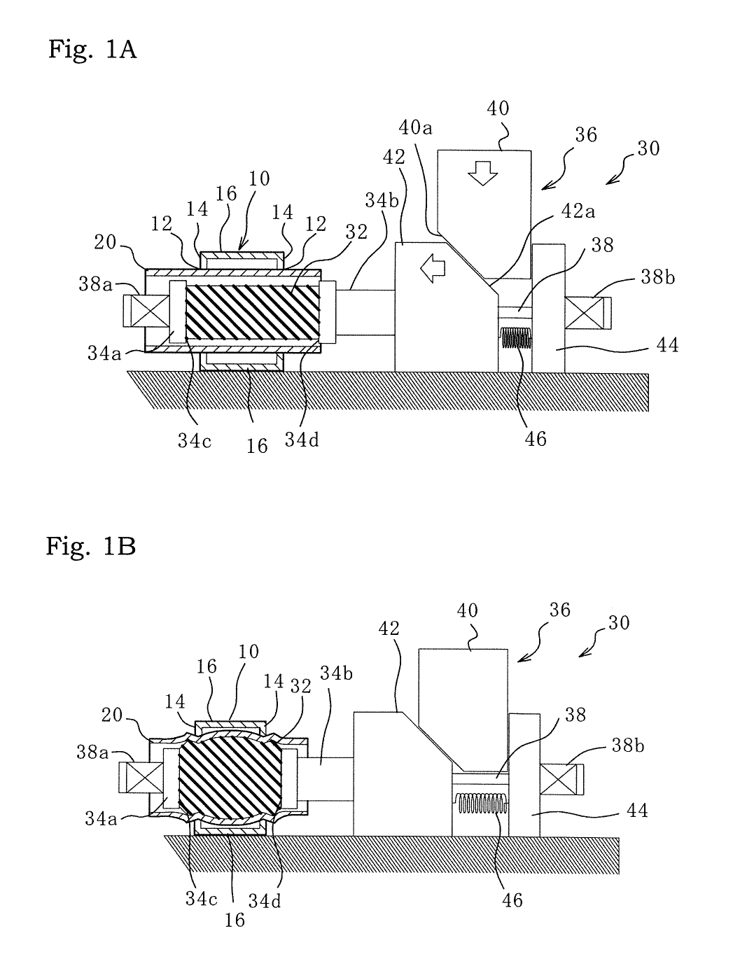

A method of joining the first member 10 and the second member 20 to each other using a press-fitting apparatus 30 will be described with reference to FIGS. 1A and 1B. In the press-fitting apparatus 30 of the present embodiment, the first member 10 and the second member 20 are joined by a press-fitting using rubber (elastic body) 32, a pair of pushers 34a and 34b, and a drive mechanism 36.

The first member 10 is a hollow pipe type, and is disposed so as to extend in a horizontal direction.

The second member 20 has a closed cross section, and includes end walls 14 and 14 provided with two respective holes 12 and 12 passing therethrough laterally, and two side walls 16 and 16 connecting the two end walls 14 and 14.

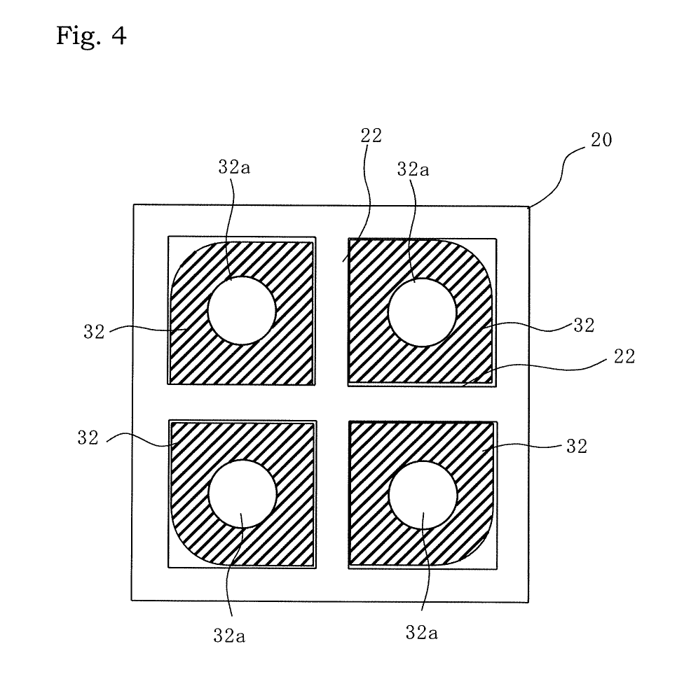

The rubber 32 is a hollow pipe type extending in the horizontal direction, and is provided at its center with a through hole 32a (refer to FIG. 4) for allowing a guide shaft 38 to be inserted thereinto. The rubber 32 is supported by the guide shaft 38 when the guide shaft 38 is inserted into the through hole 32a (refer to FIG. 4), and is maintained in posture and position. As a material of the rubber 32, it is preferable to use any one of urethane rubber, chloroprene rubber, CNR rubber (chloroprene rubber+nitrile rubber), and silicone rubber, for example. It is preferable that the rubber 32 has a Shore A hardness of 30 or more.

The pair of pushers 34a and 34b are disposed on both sides of the rubber 32, having a substantially columnar shape extending in the horizontal direction, and press the rubber 32 from both the sides to compress it. The pushers 34a and 34b respectively have pressing surfaces 34c and 34d that are formed flat, so that a load is uniformly applied to the rubber 32 when the rubber 32 is compressed. In the present embodiment, the one pusher 34a is fixed so as not to move with respect to the guide shaft 38. The other pusher 34b has an insertion hole (not illustrated) through which the guide shaft 38 is inserted. When the guide shaft 38 is inserted through the insertion hole (not illustrated), the pusher 34b is movable along the guide shaft 38. The other pusher 34b is attached to the drive mechanism 36, and thus is moved in the horizontal direction along the guide shaft 38 by the drive mechanism 36.

The drive mechanism 36 includes a cam driver 40 and a cam slider 42. The cam slider 42 has an insertion hole (not illustrated) through which the guide shaft 38 is inserted, and is movable along the guide shaft 38 in a state where the guide shaft 38 is inserted through the insertion hole.

The pusher 34b is attached to the cam slider 42 such that the insertion hole of the cam slider 42 and the insertion hole of the pusher 34b are concentric with each other. Thus, the pusher 34b is movable along the guide shaft 38 together with the cam slider 42 in a state where the guide shaft 38 is inserted through the insertion hole of the cam slider 42 and the insertion hole of the pusher 34b.

The cam slider 42 is provided on its upper portion with an inclined surface 42a for receiving a force from the cam driver 40. The cam driver 40 is movable in a vertical direction, and is provided on its lower portion with an inclined surface 40a for transmitting a force to the cam slider 42. When a downward force is applied to the cam driver 40, the force is transmitted from the cam driver 40 to the cam slider 42 via the inclined surfaces 40a and 42a. Then, the cam driver 40 is moved in the vertical direction (downward in the drawing), and the cam slider 42 is moved in the horizontal direction (the left direction in the drawing) along the guide shaft 38. That is, the drive mechanism 36 of the present embodiment has a cam mechanism composed of the cam slider 42 and the cam driver 40. For the cam driver 40, a press machine or the like that is usually used for press working or the like may be used, for example.

The drive mechanism 36 is provided on its outer side in the horizontal direction (the right side in the drawing) with a vertical wall portion 44 for stopping an outward movement of the drive mechanism 36 in the horizontal direction. The vertical wall portion 44 is provided with an insertion hole (not illustrated) through which the guide shaft 38 is inserted, and the guide shaft 38 extends outward in the horizontal direction of the vertical wall portion 44 through the insertion hole. Thus, the guide shaft 38 includes one end 38a that is fixed with respect to the guide shaft 38 together with the one pusher 34a, and the other end 38b that is fixed with respect to the guide shaft 38 on an outer side in the horizontal direction of the vertical wall portion 44.

The vertical wall portion 44 and the cam slider 42 are elastically connected by a coil spring (urging portion) 46, and the cam slider 42 is urged toward the vertical wall portion 44.

The first member 10 and the second member 20 are joined to each other by press-fitting in the following procedure.

First, the second member 20 is inserted through the hole part 12 of the first member 10, and the guide shaft 38 is inserted through the through hole 32a of the rubber 32. Subsequently, the rubber 32 with the guide shaft 38 inserted is inserted into the second member 20, and the pushers 34a and 34b are disposed on respective sides of the rubber 32, and then both the ends 38a and 38b of the guide shaft 38 are fixed. At this time, the one pusher 34a is fixed so as not to move with respect to the guide shaft 38, and the other pusher 34b is disposed to be movable along the guide shaft 38 by the drive mechanism 36. FIG. 1A shows the state at this time.

Next, a downward force is applied to the cam driver 40 of the drive mechanism 36 to move the cam driver 40 downward so that a force is transmitted to the cam slider 42 from the cam driver 40 via the inclined surfaces 40a and 42a. Then, a force in the vertical direction (downward in the drawing) is converted to a force in the horizontal direction (the left direction in the drawing). The cam slider 42 is moved in an extending direction of the guide shaft 38, for compressing the rubber 32. The one pusher 34a is fixed with respect to the guide shaft 38, and the other pusher 34b is moved together with the cam slider 42 in the left direction along the guide shaft 38. As a result, the pushers 34a and 34b move relatively closer each other, so that the rubber 32 is compressed in the extending direction of the guide shaft 38 to be expanded outward from radially inside. As described above, at least a portion of the second member 20 inserted through the hole part 12 is expanded and deformed, so that the second member 20 is joined to the first member 10 by press-fitting. FIG. 1B shows the state at this time.

While there is no illustration, when the cam driver 40 of the drive mechanism 36 is moved upward after joining by press-fitting, a force applied to the cam slider 42 in the horizontal direction (the left direction in the drawing) is removed. Then, the cam slider 42 is returned to an original position by the coil spring 46. At the time, the rubber 32 expanded in the second member 20 is returned to a natural state from a state expanded radially when a force applied thereto is removed, and its contact with the second member 20 is released. Thus, the first member 10 and the second member 20 joined by press-fitting can be easily removed from the press-fitting apparatus 30 without receiving frictional force from the rubber 32.

As described above, when the rubber 32 is expanded radially outward to uniformly expand and deform the second member 20, so that local deformation can be prevented and a load on each of the members 10 and 20 can be reduced. This is because the second member 20 can be uniformly deformed by using properties of the rubber 32 that uniformly expands outward from radially inside after compressed in the extending direction of the guide shaft 38. This enables fitting accuracy to be improved to increase joining strength. In addition, this method is also simpler than electromagnetic forming and other processing methods. Electromagnetic forming can be used only for a conductive material, and is limited in cross-sectional shape and dimension of a conductor depending on a coil to be used. In contrast, this method has no limitations with respect to_cross-sectional shape or size, regardless of its material. In addition, there is no need for electrical equipment requiring a capacitor with large capacity, and it is possible to join the two members 10 and 20 at low cost. In particular, the rubber 32 is laterally supported by the guide shaft 38, and the second member 20 is joined by press-fitting by moving the pushers 34a and 34b in the horizontal direction (the extending direction of the guide shaft 38) to compress the rubber 32, so that the second member 20 can be disposed laterally. Thus, even an elongated second member 20 can be joined by press-fitting. Here, the horizontal direction in which the guide shaft 38 extends includes an inclined direction in addition to a strict horizontal direction.

The cam mechanism of the drive mechanism 36 enables the second member 20 to be disposed in the horizontal direction with equipment for applying a compressive force in a vertical direction, which is often used in a normal press machine or the like, so that the second member 20 can be joined by press-fitting without being limited in shape. In particular, when the second member 20 is long, ordinary equipment for applying a compressive force cannot join the second member by press-fitting due to limitation on dimension, however, the present structure enables the second member 20 to be joined by press-fitting even when the second member 20 is long.

In addition, the cam slider 42 and the pusher 34b are automatically returned to their original positions by the coil spring 46, so that there is no need to manually return the cam slider 42 and the pusher 34b to the original positions, thereby workability can be improved.

When one pusher 34a is fixed with respect to the guide shaft 38, the drive mechanism 36 needs to be provided only for the other pusher 34b, thereby enabling the drive mechanism 36 to be simplified in structure. In addition, movement of the first member 10 and the second member 20 can be limited so that workability can be improved.

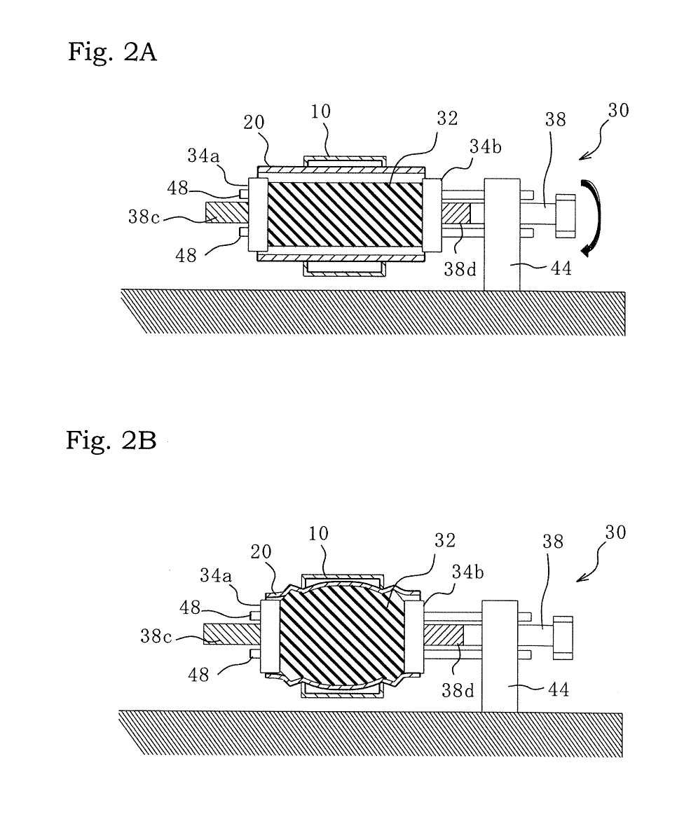

FIGS. 2A and 2B each illustrate a press-fitting apparatus 30 of a type in which a guide shaft rotates. The press-fitting apparatus 30 includes a drive mechanism 36 that does not have a cam slider 42 and a cam driver 40 as described above. The press-fitting apparatus 30 applies rotational torque to the guide shaft 38 so that the pushers 34a and 34b move relatively closer each other in the horizontal direction in an interlocked manner to compress the rubber 32.

In the press-fitting apparatus 30, the guide shaft 38 is provided with thread grooves 38c and 38d, and two support rods 48 and 48 pass through the pushers 34a and 34b, and the rubber 32. Thus, the pushers 34a and 34b, and the rubber 32 have respective insertion holes (not illustrated) corresponding to the support rods 48 and 48 passing therethrough.

When the guide shaft 38 is rotated as indicated by an arrow in the drawing, rotational torque is transmitted to the pushers 34a and 34b via the thread grooves 38c and 38d, respectively. However, the support rods 48 and 48 stop rotation of the pushers 34a and 34b, respectively, so that the pushers 34a and 34b are respectively moved along the thread grooves 38c and 38d of the guide shaft 38 without rotating. The thread groove 38c and 38d do not have the same shape, and are formed in shapes different from each other for the respective pushers 34a and 34b to move the pushers 34a and 34b closer to each other.

As described above, the press-fitting apparatus 30 applies rotational torque to the guide shaft 38 to move the pushers 34a and 34b closer to each other so that the rubber 32 is compressed in the horizontal direction to be expanded radially. As a result, the first member 10 and the second member 20 are joined to each other by press-fitting.

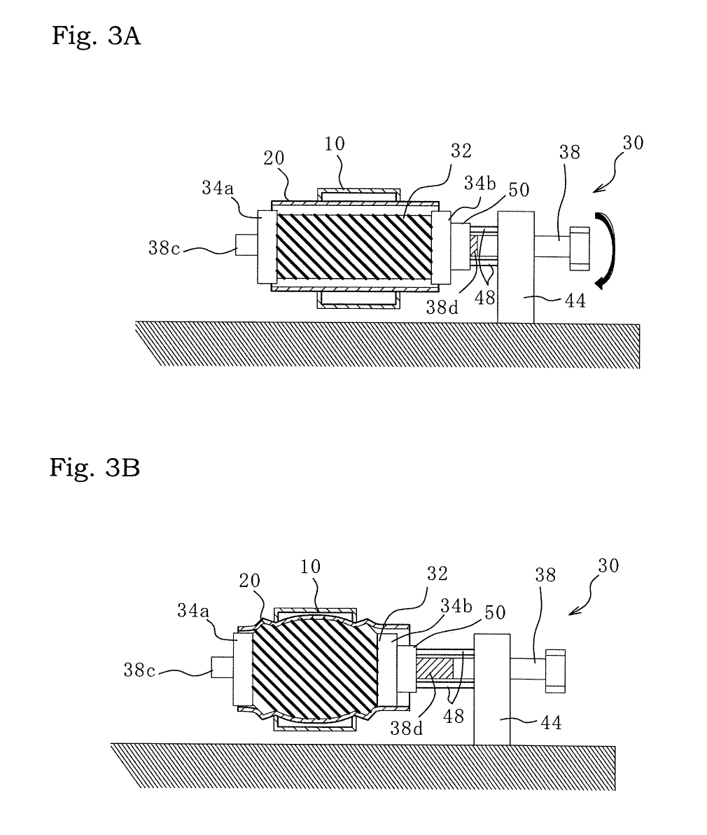

FIGS. 3A and 3B each illustrate a press-fitting apparatus 30 of another type in which a guide shaft rotates. While the press-fitting apparatus 30 of each of FIGS. 2A and 2B is provided with the thread grooves 38c and 38d (refer to FIGS. 2A and 2B) so that the pushers 34a and 34b on respective sides move closer to each other, the press-fitting apparatus 30 of each of FIGS. 3A and 3B has one pusher 34a that is fixed with respect to a guide shaft 38. A thread groove 38d is formed on only one side with respect to a joint portion so that the other pusher 34b is moved in a horizontal direction along the guide shaft 38. In addition, a pushing fixture 50 is provided on a laterally outer side (the right side in the drawing) of the pusher 34b to be laterally moved with rotation of the guide shaft 38 to laterally push and move the other pusher 34b. Support rods 48 and 48 pass through the pushing fixture 50. When the guide shaft 38 is rotated, rotational torque is transmitted to the pushing fixture 50 via the thread groove 38d. However, the support rods 48 and 48 stop rotation of the pushing fixture 50, so that the pushing fixture 50 is moved along the thread groove 38d of the guide shaft 38 without rotating. Thus, the other pusher 34b is pushed by the pushing fixture 50, and is moved along the guide shaft 38 to approach the one pusher 34a fixed with respect to the guide shaft 38.

As described above, in the press-fitting apparatus 30, as the guide shaft 38 is rotated, the other pusher 34b approaches the one pusher 34a, so that the rubber 32 is laterally compressed to be expanded radially. As a result, a first member 10 and a second member 20 are joined to each other by press-fitting.

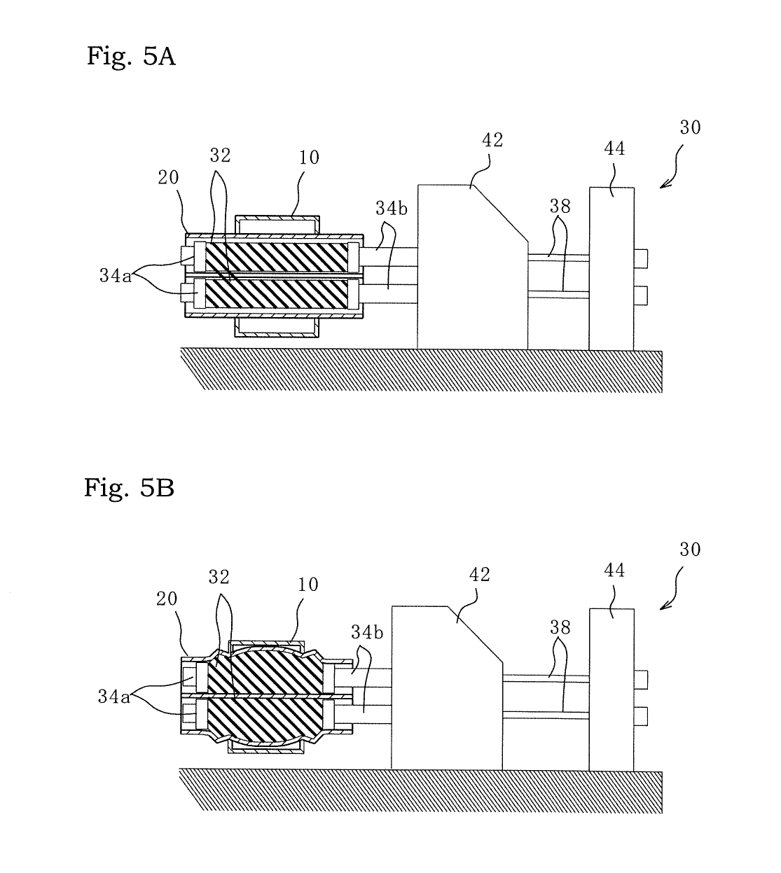

FIGS. 4 to 5B each illustrate a press-fitting apparatus 30 in which a second member 20 has partition walls 22, and a plurality of guide shafts 38 are provided. Forms of rubber 32 and the second member 20 can be variously modified. As illustrated in FIG. 4, the second member 20 may have a rectangular outer shape, and have partition walls 22 dividing its inside into four. This case requires also four pieces of rubber 32 and four guide shafts 38, to be inserted into the second member 20.

When the partition walls 22 are provided as described above, the second member 20 can be increased in strength. In addition, a cross-sectional shape of the second member 20 is not limited to a rectangular, and may have any shape. Further, the partition walls 22 are not particularly limited in shape, and may have a shape dividing the second member 20 into two, for example.

As illustrated in FIGS. 5A and 5B, while there is a plurality of guide shafts 38 and 38 and pushers 34a and 34b, the structure of other parts is the same as that of the present embodiment. As described above, the present invention is also applicable even when the second member 20 has the partition walls 22.

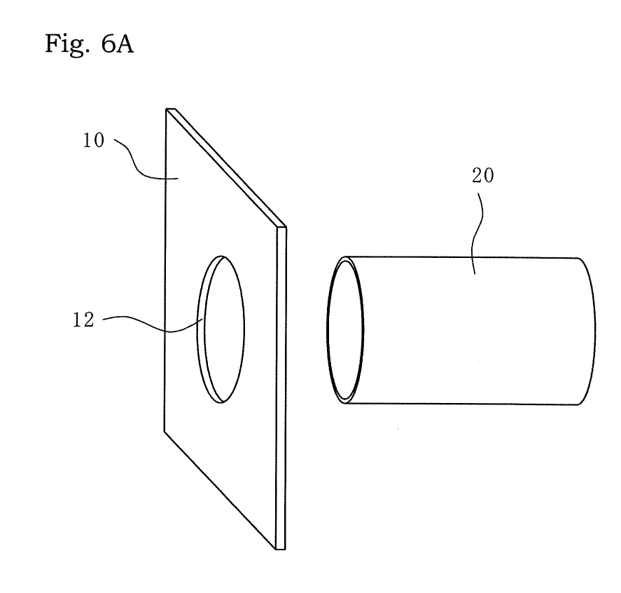

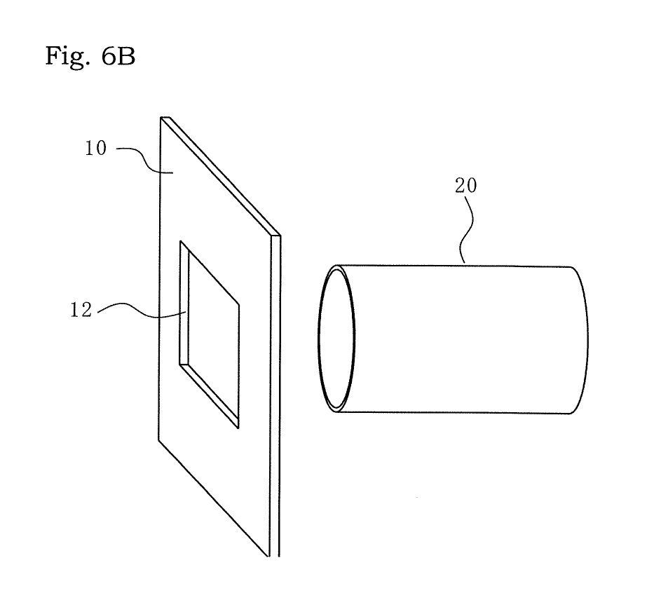

As illustrated in FIGS. 6A and 6B, the first member 10 and the second member 20 can be variously changed in form. It is preferable that the second member 20 has a cross-sectional shape similar to the hole part 12 of the first member 10 (e.g., a circular shape), as illustrated in FIG. 6A. When the hole part 12 of the first member 10 and a cross-section of the second member 20 are similar to each other in shape, the second member 20 can be uniformly expanded and deformed to be joined to the first member 10. As a result, a local load can be prevented from being applied to the first member 10 and the second member 20. However, as illustrated in FIG. 613, the present invention is applicable even when the hole part 12 of the first member 10 and the cross-section of the second member 20 are not similar in shape (e.g., circular and square shapes).

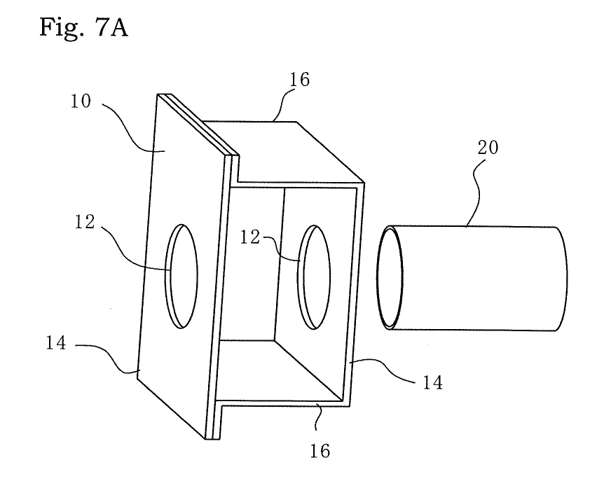

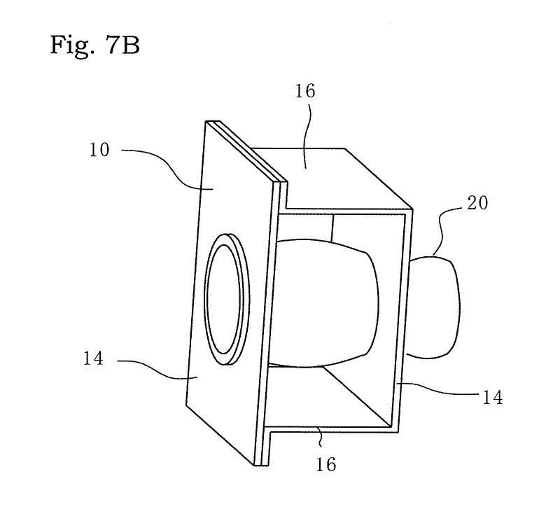

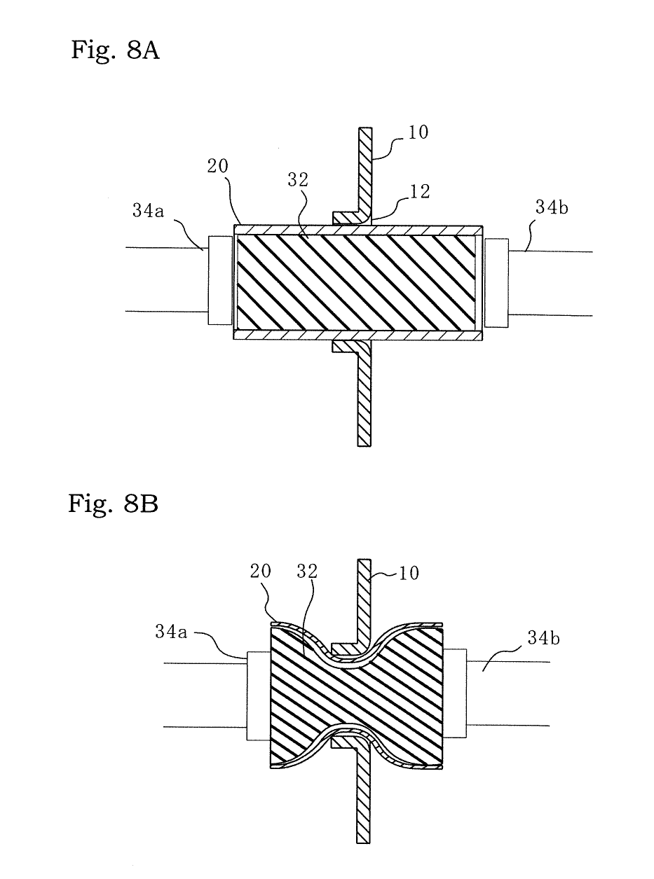

As illustrated in FIGS. 7A and 7B, two or more joint portions between the first member 10 and the second member 20 may be provided. In the case of joining at two places, the first member 10 may have a hat shape as illustrated in FIGS. 7A and 7B, or may have another shape. It is preferable that burring is applied to the hole part 12 of the first member 10, as illustrated in FIGS. 8A and 8B. This is because strength of the hole part 12 of the first member 10 can be increased by burring an edge of the hole part 12 of the first member 10. As a result, deformation of the first member 10 and damage to the second member 20 due to deformation of the first member 10 can be prevented, and joining strength can be increased by increasing a joining area by burring.

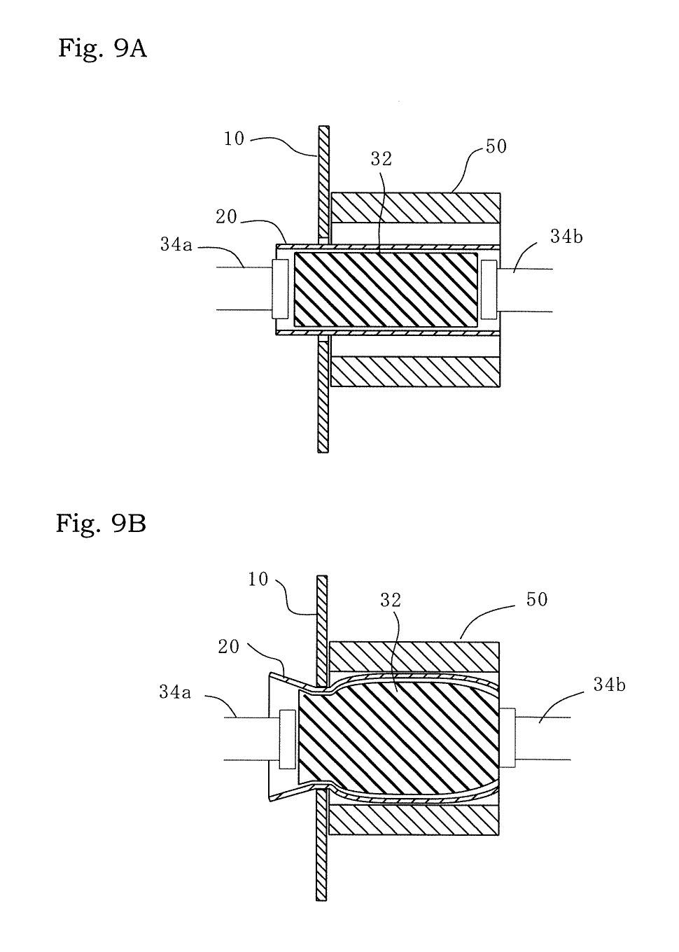

As illustrated in FIGS. 9A and 9B, the first member 10 and the second member 20 may be joined by press-fitting by using an outer frame mold 52. The outer frame mold 52 may have a cylindrical shape concentric with the second member 20. The outer frame mold 52 is disposed radially outward of the second member 20. In a state before the rubber 32 is laterally compressed to be expanded radially outward, as illustrated in FIG. 9A, a gap is provided between the second member 20 and the outer frame mold 52. When the rubber 32 is expanded radially outward by the pushers 34a and 34b from this state, as illustrated in FIG. 9B, the second member 20 can coincide with an inner surface shape of the outer frame mold 52 when being expanded and deformed.

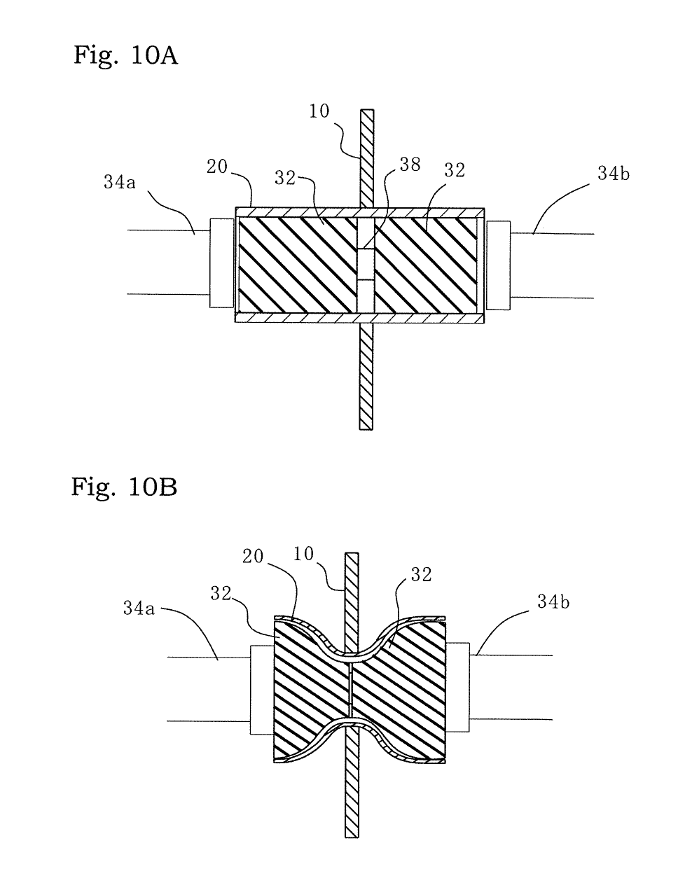

As illustrated in FIGS. 10A and 10B, the rubber 32 may be separated near the hole part 12. When the rubber 32 is separated at the hole part 12, or at a joint portion, deformation of the hole part 12 of the first member 10 can be prevented. Specifically, the rubber 32 is separated, so that no enlarging deforming force is applied to the hole part 12 to enable an original shape of the hole part 12 to be maintained.

### Second Embodiment

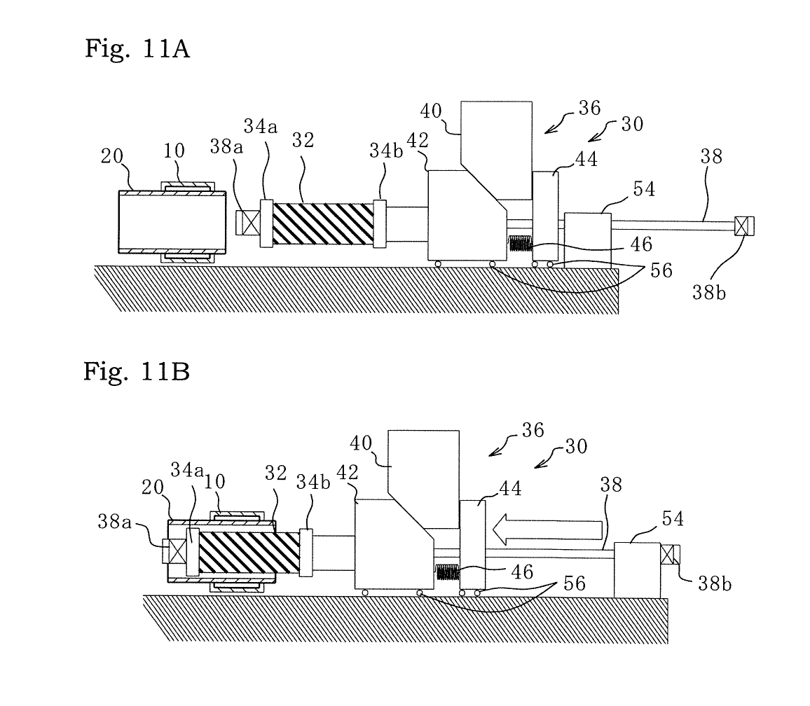

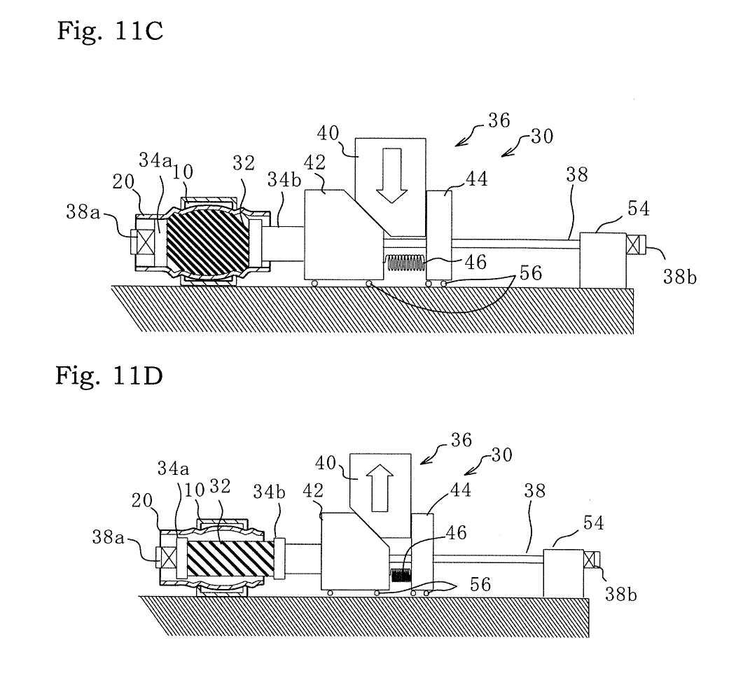

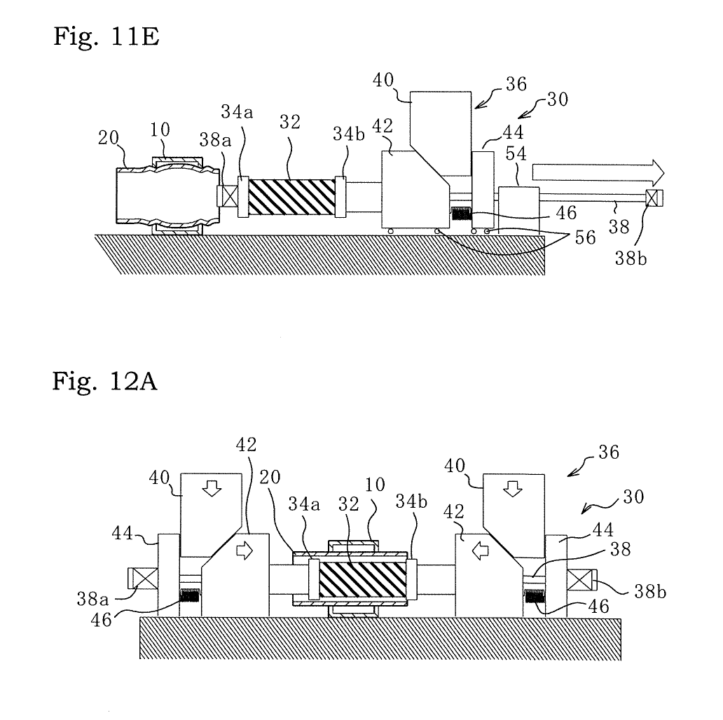

A method for joining by press-fitting of the present embodiment illustrated in FIGS. 11A to 11E uses the same structure as that of the first embodiment of FIGS. 1A and 1B other than parts related to a pusher (guide shaft moving mechanism) 54. Accordingly, parts similar to those illustrated in FIGS. 1A and 1B are denoted by the same reference numerals, and description thereof may be eliminated.

FIGS. 11A to 11E illustrate first to fifth steps of the present embodiment, respectively. In the present embodiment, wheels 56 are provided at a lower end of each of a cam slider 42 and a vertical wall portion 44, so that the cam slider 42 and the vertical wall portion 44 are movable in a horizontal direction. In addition, a cam driver 40 is also movable in the horizontal direction by a rail mechanism (not illustrated) or the like.

The pusher 54 is provided on the lateral outer side of the vertical wall portion 44. The pusher 54 supports a guide shaft 38 and moves the guide shaft 38 in the horizontal direction. A method for allowing the pusher 54 to move the guide shaft 38 is not particularly limited, and the guide shaft 38 may be fed out or drawn using a motor, a gear, or the like, for example.

The vertical wall portion 44 is fixed with respect to the guide shaft 38, and is moved together with the guide shaft 38 by the pusher 54. Accordingly, the vertical wall portion 44, the drive mechanism 36, and a pair of pushers 34a and 34b are moved together without changing their relative positions in the horizontal direction, with a movement of the guide shaft 38.

FIG. 11A illustrates a first step where the second member 20 is inserted through the hole part 12 of the first member 10. FIG. 11B illustrates a second step where the rubber 32 is inserted into the second member 20 by the pusher 54. FIG. 11C illustrates a third step where a compressive force is applied to the rubber 32 in an extending direction of the guide shaft 38 by the drive mechanism 36 to expand the rubber 32 radially outward, so that the first member 10 and the second member 20 are joined to each other by press-fitting. FIG. 11D illustrates a fourth step where the compressive force in the extending direction of the guide shaft 38 applied by the drive mechanism 36 is removed, so that the rubber 32 returns to its natural state. FIG. 11E illustrates a fifth step where the pusher 54 moves the press-fitting apparatus 30, so that the rubber 32 is pulled out from the second member 20.

As described above, since the pusher 54 moves the guide shaft 38 in the horizontal direction, the guide shaft 38 and the rubber 32 can be reliably inserted into the second member 20.

### Third Embodiment

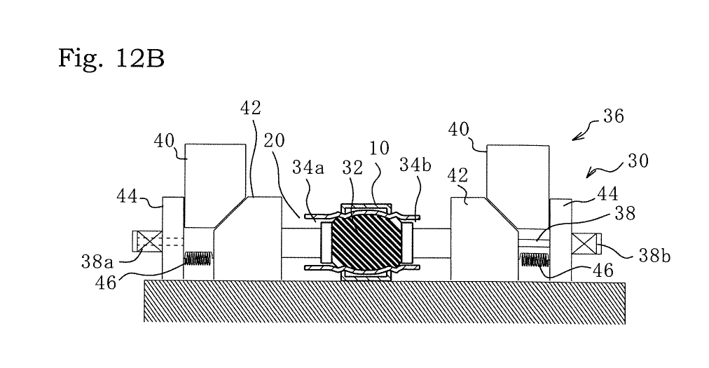

FIGS. 12A and 12B each illustrate a method for joining according to the present embodiment that uses structure similar to that of the first embodiment of each of FIGS. 1A and 1B other than parts related to structure in which pushers 34a and 34b on both sides are moved together to compress rubber 32 in a horizontal direction. Accordingly, parts similar to those illustrated in FIGS. 1A and 1B are denoted by the same reference numerals, and description thereof may be eliminated.

In the present embodiment, two drive mechanisms 36 and 36, and two vertical wall portions 44 and 44 are provided. The pair of pushers 34a and 34b are attached together to a cam slider 42, and are not fixed with respect to the guide shaft 38. This causes both the pushers 34a and 34b to move closer to each other in the horizontal direction by the drive mechanisms 36 and 36, respectively, so that the rubber 32 is compressed in an extending direction of the guide shaft 38.

Whether to use a one-side access type in which one side pusher 34b is moved with respect to rubber 32 as in the first and second embodiments, or a two-side access type in which pushers 34a and 34b on respective sides are moved with respect to rubber 32 as in the third embodiment, can be appropriately determined depending on a mode and application of joining by press-fitting.

### DESCRIPTION OF SYMBOLS

10 First member
12 Hole part
14 End wall
16 Side wall
20 Second member
22 Partition wall
30 Press-fitting apparatus
32 Rubber
32a Through hole
34a, 34b Pusher
34c, 34d Pressing surface
36 Drive mechanism
38 Guide shaft
38a One end
38b The other end
38c, 38d Thread groove
40 Cam driver
40a Inclined surface
Cam slider
42a Inclined surface
44 Vertical wall portion
46 Coil spring (urging portion)
48 Support rod
50 Pushing fixture
52 Outer frame mold
54 Pusher (guide shaft moving mechanism)
56 Wheel

1. A method for joining members comprising:
providing a first member formed with a hole part, a hollow second member, an elastic body having a through hole, a pair of pushers which are disposed on both sides of the elastic body and which support a guide shaft extending in a horizontal direction and are movable in the guide shaft extending direction, and a drive mechanism for relatively moving the pair of pushers toward each other in the guide shaft extending direction;
inserting the second member into the hole part of the first member;
inserting the guide shaft into the through hole of the elastic body;
inserting the elastic body, through which the guide shaft passes, into the second member; and
relatively moving the pair of pushers toward each other by the drive mechanism to compress the elastic body in the guide shaft extending direction to expand the elastic body outwardly, thereby expanding and deforming at least a portion of the second member inserted into the hole part to join the second member to the first member by press-fitting.

2. The method for joining members according to claim 1, wherein the drive mechanism includes a cam mechanism for converting a force applied in a direction different from the guide shaft extending direction to a force in the guide shaft extending direction, and wherein
the elastic body is compressed by the force of which the direction has been converted by the cam mechanism.

3. The method for joining members according to claim 1, wherein the drive mechanism includes an urging portion that urges one of the pushers outwardly in the guide shat extending direction, and wherein
after the elastic body is compressed in the guide shat extending direction, the one of the pushers is returned by the urging portion.

4. The method for joining members according to claim 1, wherein one of the pair of pushers is fixed.

5. The method for joining members according to claim 1, further comprising,
providing a guide shaft moving mechanism for moving the guide shaft in the horizontal direction,
wherein the elastic body, through which the guide shaft passes, is inserted into the second member by the guide shaft moving mechanism.

6. A device for joining members to join a first member formed with a hole part and a hollow second member by press-fitting using an elastic body having a through hole comprising:
a pair of pushers which support a guide shaft extending in a horizontal direction, the pair of pushers being disposed on both sides of the elastic body and being movable in the guide shaft extending direction; and
a drive mechanism for relatively moving the pair of pushers toward each other in the guide shaft extending direction, wherein
the pushers are driven by the drive mechanism, with the second member being inserted through the hole part of the first member to penetrate the first member, with the guide shaft being inserted through the through hole of the elastic body, and with the elastic body through which the guide shaft is inserted being inserted in the second member, such that the elastic body is compressed in the guide shaft extending direction and expanded outwardly, so as to expand and deform at least a portion of the second member inserted into the hole part to join the second member to the first member by press-fitting.

7. The method for joining members according to claim 2, wherein the drive mechanism includes an urging portion that urges one of the pushers outwardly in the guide shat extending direction, and wherein
after the elastic body is compressed in the guide shat extending direction, the one of the pushers is returned by the urging portion.

8. The method for joining members according to claim 2, wherein one of the pair of pushers is fixed.

9. The method for joining members according to claim 2, further comprising,
providing a guide shaft moving mechanism for moving the guide shaft in the horizontal direction,
wherein the elastic body, through which the guide shaft passes, is inserted into the second member by the guide shaft moving mechanism.
